(19) United States
(12) Patent Application Publication
(10) Pub. No.: US 2006/0125810 A1
(43) Pub. Date: Jun. 15, 2006

(54) Display device and driving apparatus thereof

(75) Inventor: Baek-Woon Lee, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/297,958

(22) Filed: Dec. 9, 2005

(30) Foreign Application Priority Data
Dec. 11, 2004 (KR) 10-2004-0104571

(51) Int. Cl. G09G 5/00

(52) U.S. Cl. 345/204

(57) ABSTRACT

The present invention relates to a display device and a driving apparatus for the display device. The display device includes a plurality of pixels arranged in a matrix; a signal controller converting input image data having a first frequency into a plurality of output image data having a second frequency for output; and a data driver converting the output image data into analog data voltages for application sequentially to the pixels.

### CROSS REFERENCE TO RELATED APPLICATION

This application claims priority from Korean Patent Application No. 10-2004-0104571 filed on Dec. 11, 2004, the contents of which are incorporated herein by reference in their entirety.

### BACKGROUND OF THE INVENTION

(a) Field of the Invention

The present invention relates to a display device and a driving apparatus for the display device.

(b) Description of Related Art

Generally, a liquid crystal display (LCD) includes a liquid crystal (LC) panel assembly including two panels provided with pixel electrodes and common electrodes, and an LC layer with dielectric anisotropy interposed therebetween. The pixel electrodes are arranged in a matrix and are connected to switching elements such as thin film transistors (TFT) which sequentially receive a data voltage on a row by row basis. The common electrode covers the entire surface of the upper panel and is supplied with a common voltage Vcom. A pixel electrode, a common electrode, and the LC layer form an LC capacitor from a circuit standpoint, and the LC capacitor together with a switching element connected thereto comprise a basic unit of a pixel.

The LCD displays images by applying an electric field to a liquid crystal layer disposed between the two panels and regulating the strength of the electric field to determine a transmittance of light passing through the liquid crystal layer. In order to protect the LC layer from deteriorating due to a one-directional electric field, the polarity of the data voltage is reversed for each frame, for each row or for each dot with respect to the common voltage, or the polarities of the data voltage and the common voltage are both reversed.

However, reversing the polarities of the data voltages causes a blurring phenomenon because it takes a long time for the LC capacitor to be charged to a target voltage due to the slow response time of the LC molecules. This problem is particularly bad for moving pictures. A motion blur results because an image is not changed to a desired image rapidly due to a low variation of the image.

To solve the above problems, an impulsive driving scheme, which inserts a black image between normal images, has been utilized.

The impulsive driving scheme has been implemented by two techniques. One is referred to as an impulsive emission technique in which the entire screen becomes black by turning off the backlight lamps. In the second technique, a cyclic resetting is performed and this is achieved by applying black data voltages to the pixels at a predetermined period together with the normal data voltages relating to a display.

However, for the impulsive driving scheme, the insertion of the black image during the predetermined time lowers a brightness of the screen.

### SUMMARY OF THE INVENTION

The present invention is directed to heighten the brightness of the screen and improve image quality.

A display device is provided, which includes a plurality of pixels arranged in a matrix; a signal controller converting input image data having a first frequency into a plurality of output image data having a second frequency for output; and a data driver converting the output image data into analog data voltages corresponding thereto for appliance to the pixel sequentially, wherein luminance of the pixels is determined depending on the data voltages, the sum of a light amount by a plurality of the output image data is the same as a light amount by the input image data, and one of a plurality of the output image data has the lowest gray when the input image data are lower than a predetermined gray.

One of a plurality of the output image data may have the highest gray when the input image data are more than a predetermined gray.

A plurality of the output image data may include a first output image data and a second output image data, and a gray of the first output image data may be more than that of the second output image data.

The light amount by the second output image data may be lower than 50% of that by the first output image data.

The second frequency may be double relative to the first frequency, and the first frequency may be 60 Hz.

The respective data voltages corresponding to the first output image data and the second output image data may be transmitted for one filed, and a period corresponding to the one field may be ½ H.

The signal controller may include a frame memory storing the input image data; and an image signal modifier outputting the first and the second output image data on the basis of the input image data from the frame memory.

The image signal modifier may include a look-up table storing the first and the second output image data as a function of the input image data and outputting the first and the second output image data corresponding to the input image data from the frame memory, and a multiplexer selecting one of the first and the second output image data from the look-up table depending on a control signal for output.

A value of the control signal may be determined whether a field has an odd number or an even number.

When a gray Pᵣ of the input image data may be in a range of 0 to 192, a gray Pᵣ₁ of the first output image data may be (255/192)×Pᵣ and the a gray Pᵣ₂ of the second output image data may be 0.

In addition, when the gray Pᵣ of the input image data may be in a range of 193 to 255, the gray Pᵣ₁ of the first output image data may be 255 and the gray Pᵣ₂ of the second output image data may be T⁻¹[2T(Pr)−T(255)] (where, T is a luminance).

A polarity of the pixel may be reversed for two fields.

The first output image data may be applied during the first field.

Data voltages corresponding to the first output image data may have polarities opposite to those corresponding to the second output image data.

Alternatively, the first output image data may be applied during the second field.

Data voltages corresponding to the first output image data may have polarities identical to those corresponding to the second output image data.

The display device may be a liquid crystal display.

A driving apparatus of a display device comprising a plurality of pixels arranged in a matrix is provided, which includes a signal controller converting input image data having a first frequency into a plurality of output image data having a second frequency for output, and a data driver converting the output image data into analog data voltages corresponding thereto for appliance to the pixel sequentially, wherein, luminance of the pixels is determined depending on the data voltages, the sum of a light amount by a plurality of the output image data is the same as a light amount by the input image data, and one of a plurality of the output image data has the lowest gray when the input image data are lower than a predetermined gray.

One of a plurality of the output image data may have the highest gray when the input image data are more than a predetermined gray.

A plurality of the output image data may include a first output image data and a second output image data, a gray of the first output image data is more than that of the second output image data and one frame is divided into two fields, and the first and the second output image data are applied during one field, respectively.

The light amount by the second output image data may be lower than 50% of that by the first output image data.

The second frequency may be double relative to the first frequency, and the first frequency may be 60 Hz.

When a gray P^{r} of the input image data may be in a range of 0 to 192, a gray P^{r1} of the first output image data may equal to (255/192)×P^{r} and the a gray P^{r2} of the second output image data may equal to 0.

When the gray Pᵣ of the input image data may be in a range of 193 to 255, the gray Pᵣ₁ of the first output image data may equal to 255 and the gray Pr2 of the second output image data may equal to T−⁻¹[2T(Pr)−T(255)] (where, T is a luminance).

A polarity of the pixel may be reversed for two fields.

The first output image data may be applied during the first field.

In this case, data voltages corresponding to the first output image data may have polarities opposite to those corresponding to the second output image data.

Alternatively, the first output image data may be applied during the second field. In this case, data voltages corresponding to the first output image data may have polarities identical to those corresponding to the second output image data.

The signal controller may include, a frame memory storing the input image data, and an image signal modifier outputting the first and the second output image data on the basis of the input image data from the frame memory.

The image signal modifier may include a look-up table storing the first and the second output image data as a function of the input image data and outputting the first and the second output image data corresponding to the input image data from the frame memory, and a multiplexer selecting one of the first and the second output image data from the look-up table depending on a control signal for output.

The display device may be a liquid crystal display.

### BRIEF DESCRIPTION OF THE DRAWINGS

The present invention will become more apparent in light of the following detailed description of preferred embodiments of the present invention with reference to the accompanying drawings in which:

FIG. 1 is a block diagram of an LCD according to an exemplary embodiment of the present invention;

FIG. 2 illustrates a structure and an equivalent circuit diagram of a pixel of an LCD according to an exemplary embodiment of the present invention;

FIG. 3 is a block diagram of a signal controller according to an embodiment of the present invention;

FIG. 4 illustrates data voltages corresponding to upper output image data and lower output image data for grays of input image data sought according to an embodiment of the present invention;

FIG. 5(a) illustrates a reversion form of application of data voltages corresponding to upper output image data to the first field; and

FIG. 5(b) illustrates a reversion form of application of data voltages corresponding to lower output image data to the second field.

### DETAILED DESCRIPTION OF EMBODIMENTS

The present invention is described fully below, with reference to the accompanying drawings, in which preferred embodiments of the inventions are shown. This invention may, however, be embodied in many different forms and the invention is not limited to the embodiments set forth herein.

In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present.

A liquid crystal display and a driving apparatus thereof which are an embodiment of a display device and a driving apparatus thereof are described below with reference to the drawings.

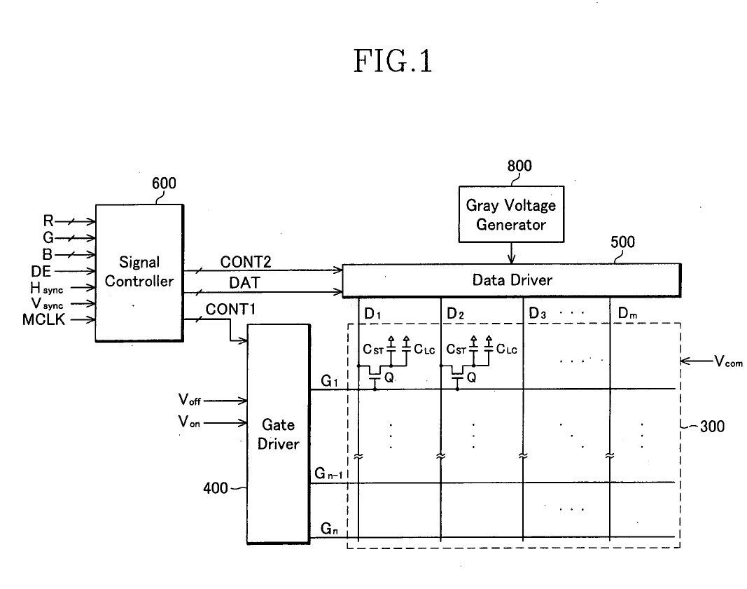

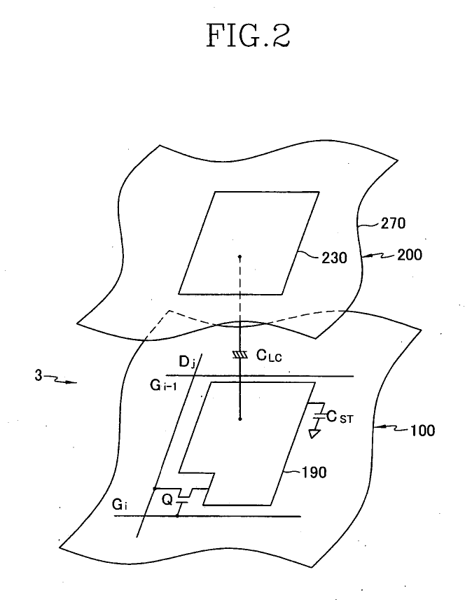

FIG. 1 is a block diagram of an LCD according to an exemplary embodiment of the present invention, and FIG. 2 illustrates a structure and an equivalent circuit diagram of a pixel of an LCD according to an exemplary embodiment of the present invention.

Referring to FIG. 1, an LCD according to an embodiment of the present invention includes a LC panel assembly 300, a gate driver 400 and a data driver 500 connected thereto, a gray voltage generator 800 connected to the data driver 500, and a signal controller 600 controlling the above-described elements.

The LC panel assembly 300, from a structural point of view is shown in FIG. 2. Panel assembly 300 includes a lower panel 100, an upper panel 200 and a liquid crystal (“LC”) layer 3 interposed therebetween, and also includes a plurality of display signal lines G₁-Gₙ and D₁-Dₘ along with a plurality of pixels that are connected thereto and arranged substantially in a matrix as illustrated in FIGS. 1 and 2.

The display signal lines G₁-Gₙ and D₁-Dₘ are provided on the lower panel 100 and include a plurality of gate lines G₁-Gₙ n transmitting gate signals (called scanning signals) and a plurality of data lines D₁-Dₘ transmitting data signals. The gate lines G₁-Gₙ extend substantially in a row direction and they are substantially parallel to each other, while the data lines D₁-Dₘ extend substantially in a column direction and they are substantially parallel to each other.

Each pixel includes a switching element Q connected to the display signal lines G₁-Gₙ and D₁-Dₘ, and an LC capacitor C_{LC} and a storage capacitor C_{ST} that are connected to the switching element Q. The storage capacitor C_{ST} may be omitted if unnecessary.

The switching element Q which is typically a TFT is provided on the lower panel 100 and has three terminals: a control terminal connected to one of the gate lines G₁-Gₙ; an input terminal connected to one of the data lines D₁-Dₘ; and an output terminal connected to the LC capacitor C_{LC} and the storage capacitor C_{ST}.

The LC capacitor C_{LC} includes a pixel electrode 190 provided on the lower panel 100, a common electrode 270 provide on the upper panel 200, and the LC layer 3 as a dielectric between the electrodes 190 and 270. The pixel electrode 190 is connected to the switching element Q. The common electrode 270 covers the entire surface of the upper panel 100 and is supplied with a common voltage Vcom. Alternatively, both the pixel electrode 190 and the common electrode 270, which have shapes of bars or stripes, may be provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100, which overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For a color display, each pixel uniquely represents one of three primary colors such as red, green and blue colors (spatial division) or sequentially represents the three primary colors in time (temporal division), thereby obtaining a desired color. FIG. 2 shows an example of the spatial division in which each pixel includes a color filter 230 representing one of the three primary colors in an area of the upper panel 200 facing the pixel electrode 190. Alternatively, the color filter 230 is provided on or under the pixel electrode 190 on the lower panel 100.

A pair of polarizers (not shown) for polarizing light are attached on outer surfaces of the lower and upper panels 100 and 200 of the panel assembly 300.

Referring back to FIG. 1, a gray voltage generator 800 generates one set or two sets of gray voltages which control the transmittance of the pixels. When two sets of the gray voltages are generated, the gray voltages in one set have a positive polarity with respect to the common voltage Vcom, while the gray voltages in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternatively, the drivers 400 and 500 may be integrated into the panel assembly 300 along with the display signal lines G₁-Gₙ and D₁-Dₘ and the TFT switching elements Q.

The signal controller 600 controls the gate driver 400 and the data driver 500.

Referring to FIG. 1, the signal controller 600 is supplied with image signals R, G and B and input control signals for controlling the display of the image signals R, G and B. The input control signals include, for example, a vertical synchronization signal Vsync, a horizontal synchronization signal Hsync, a main clock MCLK, and a data enable signal DE, from an external graphic controller (not shown). After generating gate control signals CONT1 and data control signals CONT2 and processing the image signals R, G and B suitable for the operation of the panel assembly 300 in response to the input control signals, the signal controller 600 provides the gate control signals CONT1 to the gate driver 400, and the processed image signals DAT and the data control signals CONT2 to the data driver 500. The data processing operations of the signal controller 600 include conversion of the input image data R, G and B having a predetermined frequency into a plurality of, for example, two output image data signals having a different frequency from the incoming input image data, for example, double the frequency of the input image data R, G and B for output.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D1-Dm, and a data clock signal HCLK. The data control signals CONT2 may further include an inversion control signal RVS for reversing the polarity of the data voltages (with respect to the common voltage Vcom)

The data driver 500 receives the processed image signals DAT for a pixel row from the signal controller 600 and converts the processed image signals DAT into the analog data voltages selected from the gray voltages supplied from the gray voltage generator 800 in response to the data control signals CONT2 from the signal controller 600.

Responsive to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dₘ for a turn-on time of the switching elements Q (which is called “one horizontal period” or “1H” and equals one period of the horizontal synchronization signal Hsync, the data enable signal DE, and the gate clock signal CPV). The data voltages in turn are supplied to corresponding pixels via the turned-on switching elements Q.

The difference between the data voltage and the common voltage Vcom applied to a pixel is expressed as a charged voltage of the LC capacitor C_{LC}, i.e., a pixel voltage. The liquid crystal molecules have orientations depending on a magnitude of the pixel voltage and the orientations determine a polarization of light passing through the LC capacitor C_{LC}. The polarizers convert light polarization into light transmittance.

By repeating the above-described procedure, all gate lines G₁-Gₙ are sequentially supplied with the gate-on voltage Von during a frame, thereby applying the data voltages to all pixels. When a next frame starts after finishing one frame, the inversion control signal RVS is applied to the data driver 500 to control the polarity of the data voltages to achieve “frame inversion”. The inversion control signal RVS may be controlled such that the polarity of the data voltages flowing in a data line in one frame is reversed (e.g.: “row inversion”, “dot inversion”), or the polarity of the data voltages in one packet is reversed (e.g.: “column inversion”, “dot inversion”).

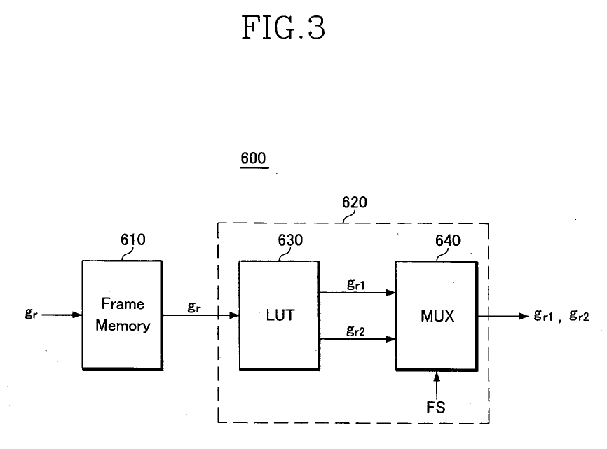

Referring to FIG. 3, the signal controller 600 includes a frame memory 610 and an image signal modifier 620 connected thereto.

The frame memory 610 stores image data by frame. The image data stored in the frame memory 610 is referred to herein as ‘input image data’ and denoted by ‘gᵣ’.

The image signal modifier 620 receives the input image data gᵣ stored in the frame memory 610 sequentially and converts each of the input image data gᵣ into a plurality of, for example, first and second output image data gᵣ₁, gᵣ₂, for output. In detail, the image signal modifier 620 reads the input image data gᵣ once from the frame memory 610 and converts them into the first output image data gᵣ₁ for output sequentially, and, subsequently, reads the input image data gᵣ once again therefrom and converts them into the second output image data gᵣ₂ for output sequentially. After applying data voltages corresponding to the first output image data to the data lines D₁-Dₘ, the data driver 500 applies data voltages corresponding to the second output image data to the data lines D₁-Dₘ. Hereinafter, periods when the first and the second output image data gᵣ₁ and gᵣ₂ are outputted and periods when the data voltage corresponding to the first and the second output image data gᵣ₁ and gᵣ₂ are applied are referred to as ‘a field’, respectively. The periods of the two fields are ½H, respectively. The image signal modifier 620 is described below in detail.

Since the input image data gr stored in the frame memory 610 is read twice, a read frequency or an output frequency of the frame memory 610 is double that of a write frequency or an input frequency. Accordingly, when an input frame frequency of the frame memory 610 is 60 Hz, an output field frequency and a frequency for applying the data voltages are 120 Hz.

For the two output image data gᵣ₁ and gᵣ₂, the sum of the light amount of light from the pixels by the first and the second output image data gᵣ₁ and gᵣ₂ is the same as that by the input image data gᵣ before modification. As used herein, the amount of light is equal to the luminance multiplied by the time for holding the luminance.

In this case, when a luminance corresponding to the input image data gᵣ is assumed to be T(gᵣ), a luminance corresponding to the first output image data gr1 is assumed to be T(_{gr1}) and a luminance corresponding to the second output image data T(_{gr2}), Equation 1 is as follows:
2T(gᵣ)=T(gᵣ₁)+T(gᵣ₂) Equation 1

In addition, one of grays Pᵣ₁ and Pᵣ₂ corresponding to the two output image data gᵣ₁ and gᵣ₂ is larger than or the same as the other. That is, Pᵣ₁≧Pᵣ₂ or Pᵣ₁≦Pᵣ₂.

Output image data having a larger gray voltage is referred to as ‘upper output image data’, and output image data having a smaller gray voltage are referred to as ‘lower output image data’ of the two grays Pᵣ₁ and Pᵣ₂ corresponding to the two output image data gᵣ₁ and gᵣ₂, and, at this time, the upper output image data may be output first, or the lower output image data may be output first. In this case, a field during output of the upper output image data is referred to as ‘an upper field’, and a field during output of the lower output image data is referred to as a lower field.

A light amount by the lower output image data does not preferably exceed about 50% of that by the upper output image data, and a gray of the lower output image data becomes 0, i.e., a black gray, or becomes near thereto so that an effect of an impulsive driving is given.

An embodiment for obtaining the upper output image data and the lower output image data for satisfying the above conditions and giving the effect of the impulsive driving is described below in detail.

In the present embodiment, for Pᵣ₁≧Pᵣ₂, the first output image data gᵣ₁ having the gray Pᵣ₁ is referred to as upper output image data and the second output image data gᵣ₂ having the gray Pᵣ₂ is referred to lower output image data, and the upper output image data is assumed to be output prior to the lower output image data.

When the input image data gᵣ stored in the frame memory 610 is 8 bits, the gray Pᵣ of the input image data ranges from 0 to 255, and the luminance T(gᵣ) of the input image data gᵣ having the gray Pᵣ has the following relation.
T(gᵣ)=α(Pᵣ/255)γ

When γ=2.5 and the gray Pᵣ of the input image data gᵣ is 192, a luminance for 192 corresponds to a half of that for 255, the highest gray. Accordingly, the gray Pᵣ₁ of the upper output image data gᵣ₁ and the gray Pᵣ₂ of the lower output image data gᵣ₂ is determined as follows:
(1) if 0≦Pᵣ≦192, Pᵣ₁=(255/192)×Pᵣ₁, Pᵣ₂₌₀; and
(2) if 193≦Pᵣ≦255, Pᵣ₁₌₂₅₅, Pᵣ₂=T^{-1[2}T(Pᵣ)−T(255)].

That is, when the gray Pᵣ of the input image data gᵣ is in the range (1), the gray Pᵣ₁ is the upper output image data gᵣ₁ is determined as the highest gray, 255, depending on the gray Pᵣ of the input image data gᵣ, the gray Pᵣ₂ of the lower output image data gᵣ₂ is 0.

When the gray Pᵣ of the input image data gᵣ is in the range (2), the gray Pᵣ₁ of the upper output image data gᵣ₁ have the highest gray, 255, and the gray Pᵣ₂ of the lower output image data gᵣ₂ has a value satisfying Equation 1. When the gray Pᵣ of the input image data gᵣ is 255, both the gray Pᵣ₁ of the upper output image data gᵣ₁ and the gray Pᵣ₂ of the lower output image data gᵣ₂ data become 255.

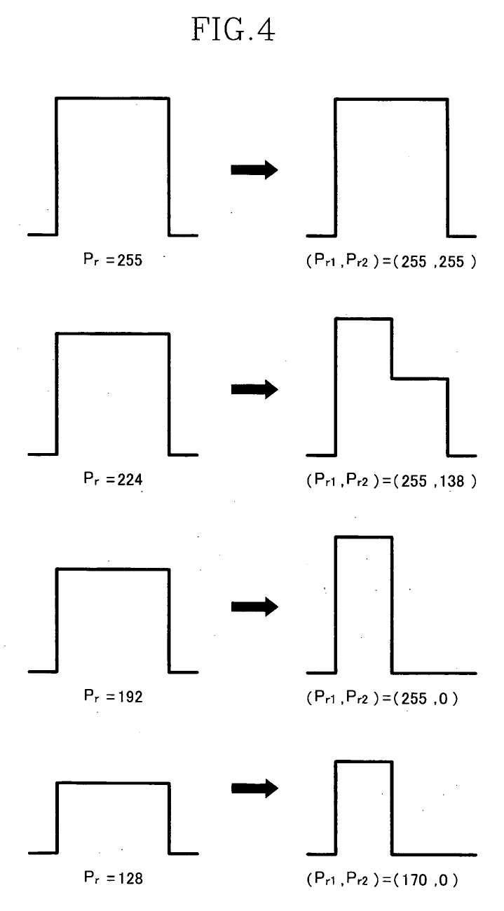

When the grays Pᵣ of the input image data gᵣ are 128, 192, 224 and 255, respective data voltages corresponding to the respective upper output image data gᵣ₁ and the respective lower output image data gᵣ₂ obtained by the relations (1) and (2) are shown in FIG. 4.

As shown in FIG. 4, on application of the data voltages corresponding to the output image data gᵣ₁ and gᵣ₂ during each field, when the gray Pᵣ of the input image data gᵣ is lower than 192, the gray Pᵣ₁ of the upper output image data gᵣ₁ is selected in a range lower than 255, the highest gray. At this time, the gray Pᵣ₁ of the upper output image data gᵣ₁ is larger than the gray Pᵣ of the input image data gᵣ. Since the data voltages corresponding to the respective output image data gᵣ₁ and gᵣ₂ are applied to the corresponding pixels during the first and the second fields, the period when the data voltages corresponding to the upper or the lower output image data gᵣ₁ and gᵣ₂ are applied to the pixels is reduced by about ½ relative to that when the data voltages corresponding to the input image data gᵣ are applied thereto. Accordingly, data voltages larger than the data voltages corresponding to the input image data gᵣ need to be applied to the pixels so that a light amount almost the same as that by the input image data gᵣ may be obtained. In this case, since only the data voltages corresponding to the upper output image data gᵣ₁ can substantially provide the light amount by the input image data gᵣ, the gray Pᵣ₂ of the lower output image data gᵣ₂ becomes 0 in order to give the impulsive driving effect.

However, when the gray Pᵣ of the input image data gᵣ exceeds 192 and, in this case, the gray Pᵣ₂ of the lower output image data gᵣ₂ is 0, although the gray Pᵣ₂ of the upper output image data gᵣ₁ is selected to be 255, the highest gray, a light amount thereby the same as that by the input image data gᵣ cannot be obtained. That is, a loss of the luminance occurs. Accordingly, the gray Pᵣ₂ of the lower output image data gᵣ₂ is selected to be a value larger than 0 so that the insufficient light amount is compensated by the light amount by the lower output image data gᵣ₂. Although the gray Pᵣ₂ of the lower image data gᵣ₂ giving the impulsive driving effect is not 0, the gray Pᵣ₂ thereof has a lower gray, for example, a gray near to 0, and, thus, the impulsive driving effect is obtained to some degree.

Operation of the signal controller 600 which transmits the two output image data gᵣ₁ and gᵣ₂ obtained in this way to the data driver 500 is described below with reference to FIG. 4.

As described above, the signal controller 600 includes the frame memory 610 and the image signal modifier 620. The image signal modifier 620 includes a look-up table (LUT) 630 connected to the frame memory 610 and a multiplexer 640 connected to the LUT 630 and receiving a field selecting signal FS. The field selecting signal FS is determined in many ways, such as odd number and even number of the fields, or using a counter. In addition, the field selecting signal FS may be generated in the internal signal controller 600 or may be provided from an external device.

The LUT 630 of the image signal modifier 620 stores the upper output image data gᵣ₁ and the lower output image data gᵣ₂ as a function of the input image data gᵣ. Accordingly, the LUT 630 responds to the input image data gᵣ to output the upper and the lower output image data gᵣ₁ and gᵣ₂ according thereto to the multiplexer 640.

The multiplexer 640 selects one of the upper and the lower output image data gᵣ₁ and gᵣ₂ from the LUT 630, depending on the field selecting signal FS, for output to the data driver 500 sequentially.

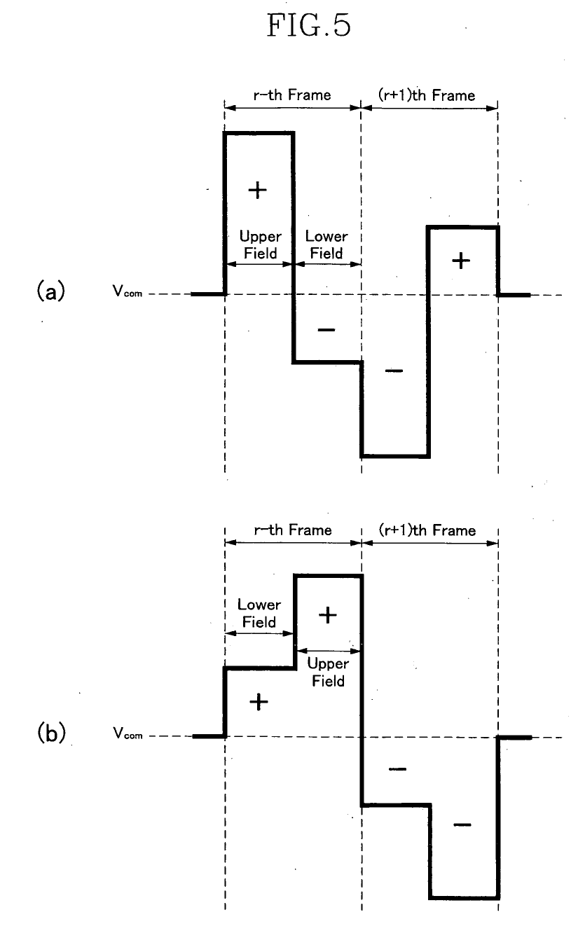

The data voltages corresponding to the upper output image data and the lower output image data gᵣ₁ and gᵣ₂ applied to the pixels via the data lines D₁-Dₘ through the data driver 500 as described above have reversion forms as shown in FIG. 5. FIG. 5(a) illustrates the reversion form on application of the data voltages corresponding to the upper output image data to the first field, and FIG. 5(b) illustrates the reversion form on application of the data voltages corresponding to the lower output image data to the second field.

Polarities of the data voltages corresponding to the upper output image data have to be identical to those of a previous field adjacent thereto so that a charging speed of pixels by the upper output image data affecting images is reduced.

In addition, the polarities of the data voltages corresponding to the upper output image data have to be reversed for each frame and those of the data voltages corresponding to the lower output image data have to be reversed for each frame, and thus an average for a pixel voltage is not inclined to a positive polarity or a negative polarity.

Accordingly, when the upper output image data are applied during the first field, the polarities of the data voltages applied during two fields are opposite to each other and those applied during adjacent frames are opposite, too, and the polarity of each pixel is reversed for two fields, as shown in FIG. 5(a).

When the upper output image data are applied during the second field, the polarities of the data voltages applied during two fields within one frame are identical and those applied during two adjacent frames are opposite to each other, and each pixel is reversed for two fields, as shown in FIG. 5(b).

According to the present invention, the conversion of the input image data into a plurality of the output image data improves the luminance and image deteriorations such as an image sticking or a blurring phenomenon by the impulsive driving effect.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A display device comprising:
a plurality of pixels arranged in a matrix;
a signal controller adapted to convert input image data having a first frequency into a plurality of output image data having a second frequency and provide the plurality of output image data at an output;
a data driver having an input coupled to the output of the signal controller, the data driver being adapted to convert the output image data into analog data voltages for application sequentially to the pixels,
wherein, a luminance of the pixels is determined as a function of the analog data voltages, and further wherein
the sum of an amount of light provided by a plurality of the output image data is the same as an amount of light provided by the input image data, and
one of a plurality of the output image data having a smaller gray voltage when the input image data are lower than a predetermined gray voltage.

2. The display device of claim 1, wherein one of a plurality of the output image data has a higher gray voltage when the input image data are greater than a predetermined gray voltage.

3. The display device of claim 2, wherein a plurality of the output image data comprises a first output image data and a second output image data, and a gray voltage of the first output image data is greater than that of the second output image data.

4. The display device of claim 3, wherein the amount of light provided by the second output image data is less than 50% of that provided by the first output image data.

5. The display device of claim 3, wherein the second frequency is double that of the first frequency.

6. The display device of claim 5, wherein the first frequency is 60 Hz.

7. The display device of claim 3, wherein the respective data voltages corresponding to the first output image data and the second output image data are transmitted for one field, and a period corresponding to the one field is ½ H.

8. The display device of claim 1, wherein the signal controller comprises:
a frame memory adapted to store the input image data; and
an image signal modifier adapted to provide the first and the second output image data as a function of the input image data received from the frame memory.

9. The display device of claim 8, wherein the image signal modifier comprises:
a look-up table adapted to store the first and the second output image data as a function of the input image data and output the first and the second output image data corresponding to the input image data from the frame memory; and
a multiplexer coupled to the look-up table, wherein the multiplexer is adapted to select one of the first and the second output image data from the look-up table as a function of a control signal.

10. The display device of claim 9, wherein a value of the control signal is determined as a function of whether the field has an odd number or an even number.

11. The display device of claim 3, wherein, when a gray voltage Pᵣ of the input image data is in a range of 0 to 192, a gray Pᵣ₁ of the first output image data equals to (255/192)×Pᵣ and the a gray Pᵣ₂ of the second output image data equals to 0.

12. The display device of claim 3, wherein, when the gray voltage Pᵣ of the input image data is in a range of 193 to 255, the gray Pᵣ₁ of the first output image data equals to 255 and the gray Pᵣ₂ of the second output image data equals to T⁻¹[2T(Pᵣ)−T(255)] (where, T is a luminance).

13. The display device of claim 7, wherein a polarity of the pixel is reversed for two fields.

14. The display device of claim 13, wherein the first output image data is applied during the first field.

15. The display device of claim 14, wherein data voltages corresponding to the first output image data have polarities opposite to those corresponding to the second output image data.

16. The display device of claim 13, wherein the first output image data are applied during the second field.

17. The display device of claim 16, wherein data voltages corresponding to the first output image data have polarities identical to those corresponding to the second output image data.

18. The display device of claim 1, wherein the display device is a liquid crystal display.

19. A driving apparatus of a display device comprising a plurality of pixels arranged in a matrix comprising:
a plurality of pixels arranged in a matrix;
a signal controller adapted to convert input image data having a first frequency into a plurality of output image data having a second frequency and provide the plurality of output image data at an output; and
a data driver having an input coupled to the output of the signal controller, the data driver being adapted to convert the output image data into analog data voltages application sequentially to the pixels,
wherein, a luminance of the pixels is determined as a function of the analog data voltages, and further wherein
the sum of an amount of light provided by a plurality of the output image data is the same as an amount of light provided by the input image data, and
one of a plurality of the output image data having a smaller gray voltage when the input image data are lower than a predetermined gray voltage.

20. The driving apparatus of claim 19, wherein one of a plurality of the output image data has a higher gray voltage when the input image data are greater than a predetermined gray voltage.

21. The driving apparatus of claim 20, wherein a plurality of the output image data comprises a first output image data and a second output image data, a gray voltage of the first output image data is more than that of the second output image data and one frame is divided into two fields, and the first and the second output image data are applied during one field, respectively.

22. The driving apparatus of claim 21, wherein the amount of light provided by the second output image data is less than 50% of that provided by the first output image data.

23. The driving apparatus of claim 21, wherein the second frequency is double that of the first frequency.

24. The driving apparatus of claim 23, wherein the first frequency is 60 Hz.

25. The driving apparatus of claim 21, wherein, when a gray voltage Pᵣ of the input image data is in a range of 0 to 192, a gray Pᵣ₁ of the first output image data equals to (255/192)×Pᵣ and the a gray Pᵣ₂ of the second output image data equals to 0.

26. The driving apparatus of claim 21, wherein, when the gray voltage Pᵣ of the input image data is in a range of 193 to 255, the gray Pᵣ₁ of the first output image data equals to 255 and the gray Pᵣ₂ of the second output image data equals to T⁻¹1[2T(Pᵣ)−T(255)] (where, T is a luminance).

27. The driving apparatus of claim 21, wherein a polarity of the pixel is reversed for two fields.

28. The driving apparatus of claim 27, wherein the first output image data is applied during the first field.

29. The driving apparatus of claim 28, wherein data voltages corresponding to the first output image data have polarities opposite to those corresponding to the second output image data.

30. The driving apparatus of claim 27, wherein the first output image data are applied during the second field.

31. The driving apparatus of claim 30, wherein data voltages corresponding to the first output image data have polarities identical to those corresponding to the second output image data.

32. The driving apparatus of claim 19, wherein the signal controller comprises:
a frame memory storing the input image data; and
an image signal modifier outputting the first and the second output image data on the basis of the input image data from the frame memory.

33. The driving apparatus of claim 32, wherein the image signal modifier-comprises:
a look-up table adapted to store the first and the second output image data as a function of the input image data and output the first and the second output image data corresponding to the input image data from the frame memory; and
a multiplexer coupled to the look-up table, wherein the multiplexer is adapted to select one of the first and the second output image data from the look-up table as a function of a control signal.

34. The driving apparatus of one of claim 19, wherein the display device is a liquid crystal display.
